(19) United States
(12) Patent Application Publication
(10) Pub. No.: US 2018/0331974 A1
(43) Pub. Date: Nov. 15, 2018

(54) METHOD AND APPARATUS FOR CONTROLLING AND FACILITATING CONTROL OF DATA STREAM OF USER IN SDN NETWORK

(71) Applicant: Alcatel Lucent, Nozay (FR)

(72) Inventors: Yuanyuan HE, Shanghai (CN); Xin QU, Shanghai (CN); Zhi WANG, Shanghai (CN); Yigang CAI, Naperville, IL (US)

(73) Assignee: Alcatel Lucent, Nozay (FR)

(21) Appl. No.: 15/776,987

(22) PCT Filed: Nov. 23, 2016
(86) PCT No.: PCT/IB2016/001814

§ 371 Date: May 17, 2018

(30) Foreign Application Priority Data
Dec. 1, 2015 (CN) 201510866913.6

(51) Int. Cl. H04L 12/927; H04L 12/725; H04L 12/813; H04L 12/721; H04L 12/24; G06F 17/30

(52) U.S. Cl. CPC H04L 47/808; H04L 45/308; H04L 47/20; G06F 17/30867; H04L 41/20; G06F 17/30876; H04L 45/38

(57) ABSTRACT

A method for controlling a user data flow in an SDN controller of an SDN network includes retrieving user profile information from a user information database via an Ss interface with the user information database; controlling a data flow of a user based on the user profile information. The SDN controller is enabled to have a capability of obtaining user profile information through a newly added interface between the SDN controller and the user information database, such that the SDN controller may control a user data flow based on the user profile information.

### FIELD OF THE INVENTION

The present invention relates to a software defined network (SDN), and more specifically to a method and apparatus for controlling and facilitating control of a data flow of a user in an SDN network.

### BACKGROUND OF THE INVENTION

In an LTE time, with the rapid growth of data servers, the communication system plays a role of a wireless data transmission pipeline for receiving and transmitting data. Terminal application companies get many revenues, while communication carriers, as pipeline providers for the communication, need to be capable of providing a unified service and policy capability center to ensure business success for service operations.

The mobile communication network divides the mobile wideband services into two parts: one part is a mobile pipeline consisting of mobile access and a core network, which provides bearings for the mobile wideband service; the other part is a mobile service part, which provides value-added services, including functions such as service compression, video optimization, webpage buffer, HTTP head enhancement, firewall, etc., and which can greatly improve user experience, thereby increasing the user's loyalty. Besides, the mobile service part may also provide differentiated services to reduce the carriers' operation overheads. However, the current network architecture model has some drawbacks: 1. It is needed to upgrade the existing system when adding new service, such that the work load is very large. 2. Modification of a single service needs to reconfigure all services chained together. 3. Failure of a single service might interrupt all services.

SDN (Software Defined Network) is a new solution for the communication carrier to realize service control. The key idea of the SDN is decoupling the control layer from the data layer. The SDN may be disposed between the core network and the Internet to control data of different types to go through different paths. But until now, the SDN does not own a functionality of controlling a data flow based on the attribute information of a subscriber, which can only control a data flow channel based on the data service type. If the SDN controller can control the user's data flow based on the user's profile information, some customized services may be provided for the user, and a flexible control policy is implemented for the services based on the user profiles, thereby enhancing user experience. However, it is a valuable issue to study how to obtain user profile information in the SDN network and how to control user data flow based on the user profile information.

### SUMMARY OF THE INVENTION

The present invention provides a method and apparatus for controlling a user data flow in an SDN network.

According to one aspect of the present invention, there is provided a method for controlling a user data flow in an SDN controller of an SDN network, the method comprising:

retrieving user profile information from a user information database via an Ss interface with the user information database;

controlling a data flow of a user based on the user profile information.

According to another aspect of the present invention, there is provided a method for facilitating control of a user data flow in a user information database of an SDN network, the method comprising:

providing user profile information to an SDN controller via an Ss interface with the SDN controller.

According to another aspect of the present invention, there is provided an apparatus for controlling a user data flow in an SDN controller of an SDN network, the apparatus comprising:

a module configured to retrieve user profile information from a user information database via an Ss interface with the user information database;

a module configured to control a data flow of a user based on the user profile information.

According to a further aspect of the present invention, there is provided an apparatus for facilitating control of a user data flow in a user information database of an SDN network, the apparatus comprising:

a module configured to provide user profile information to an SDN controller via an Ss interface with the SDN controller.

Compared with the prior art, the present invention has the following advantages: the present invention enables the SDN controller to have a capability of obtaining user profile information through a newly added interface between the SDN controller and the user information database, such that the SDN controller may control a user data flow based on the user profile information. Based on the solution of the present invention, a customized service may be provided to the user, and a flexible control policy may be implemented for the services based on the user profile, thereby bring a better user experience to the user. Meanwhile, the SDN controller controls the user data flow based on the user profile information, and also optimizes utilization of the network resource, thereby enhancing the flexibility of the network.

### DETAILED DESCRIPTION OF THE PREFERRED EMBODIMENTS

The present invention will be understood comprehensively through the detailed depiction and the accompanying drawings below, wherein the same units are denoted by the same reference numerals. The accompanying drawings are only provided for illustration and therefore are not intended to limit the present invention:

FIG. 1 shows a schematic diagram of an SDN network architecture;

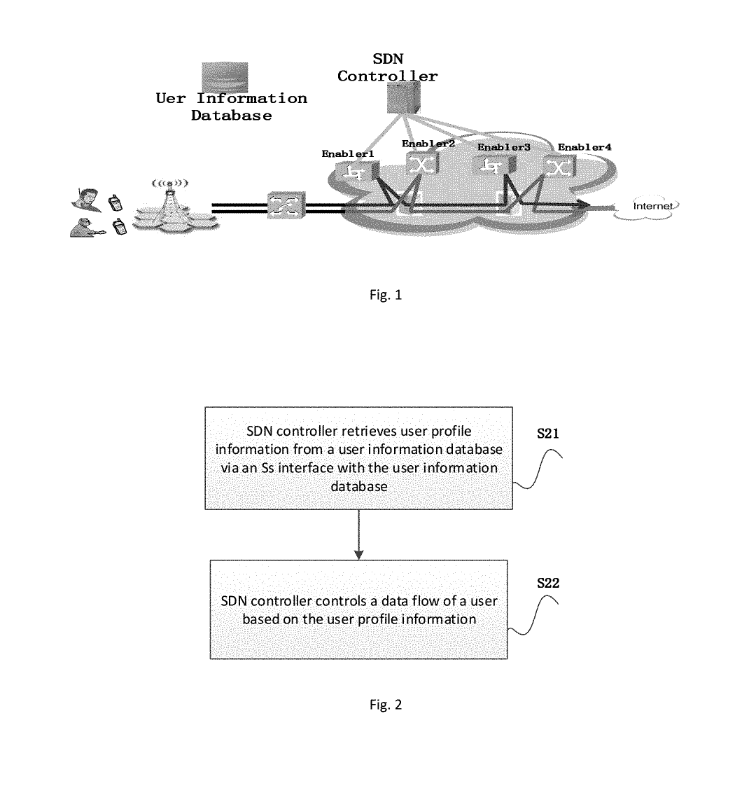

FIG. 2 shows a flow diagram of a method for controlling a user data flow at an SDN controller in an SDN network according to an embodiment of one aspect of the present invention;

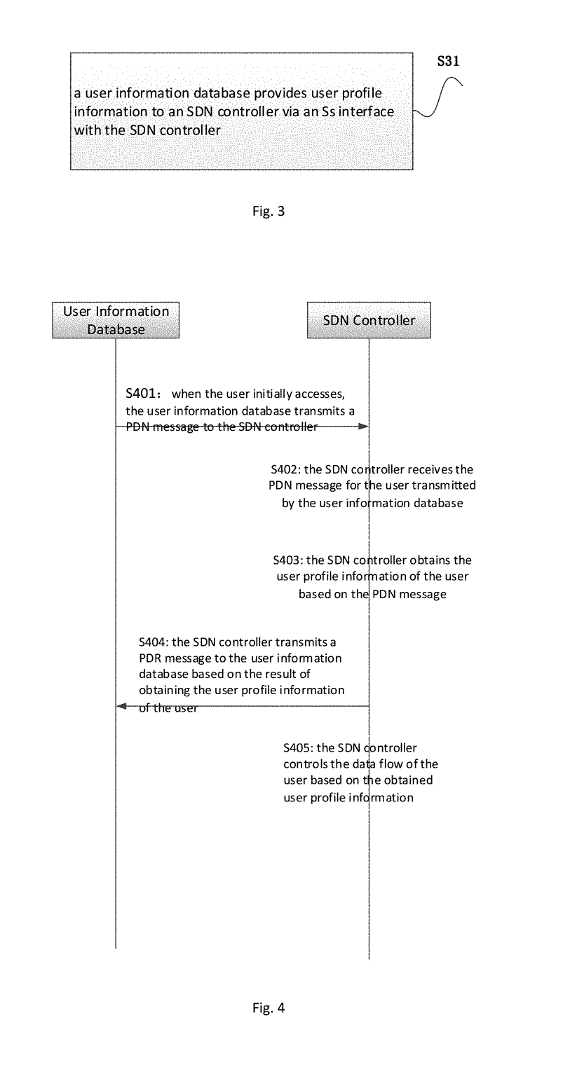

FIG. 3 shows a flow diagram of a method for facilitating control of a user data flow in a user information database in an SDN network according to an embodiment of another aspect of the present invention;

FIG. 4 shows a message interacting diagram for communication between the SDN controller and the user information database when the user initially accesses in one preferred embodiment of the present invention;

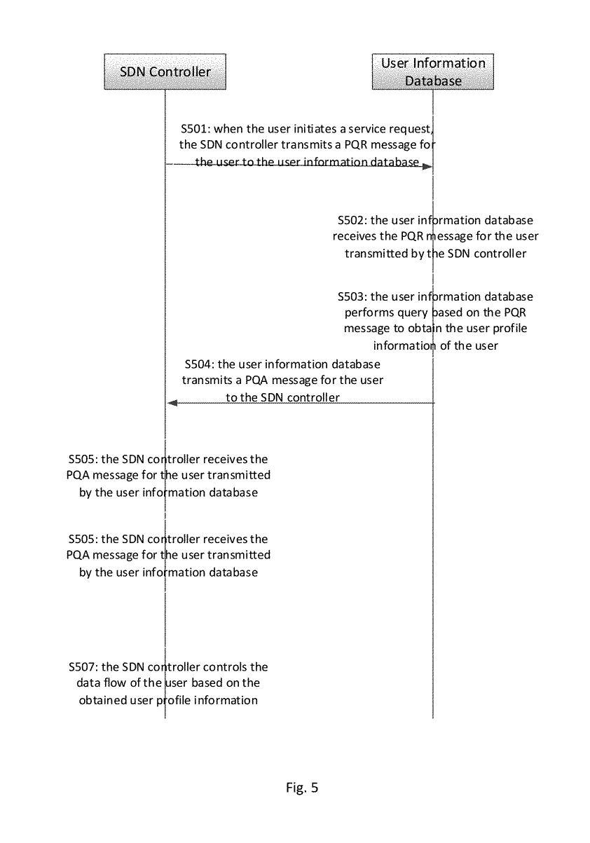

FIG. 5 shows a message interaction diagram for communication between the SDN controller and the user information database when the user performs service application in a preferred embodiment of the present invention;

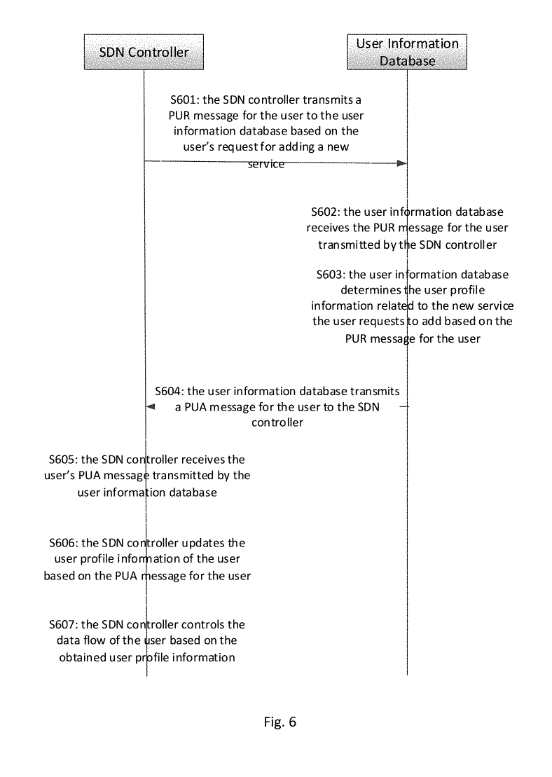

FIG. 6 shows a message interaction diagram for communication between the SDN controller and the user information database when the user registers a new service in one preferred embodiment of the present invention;

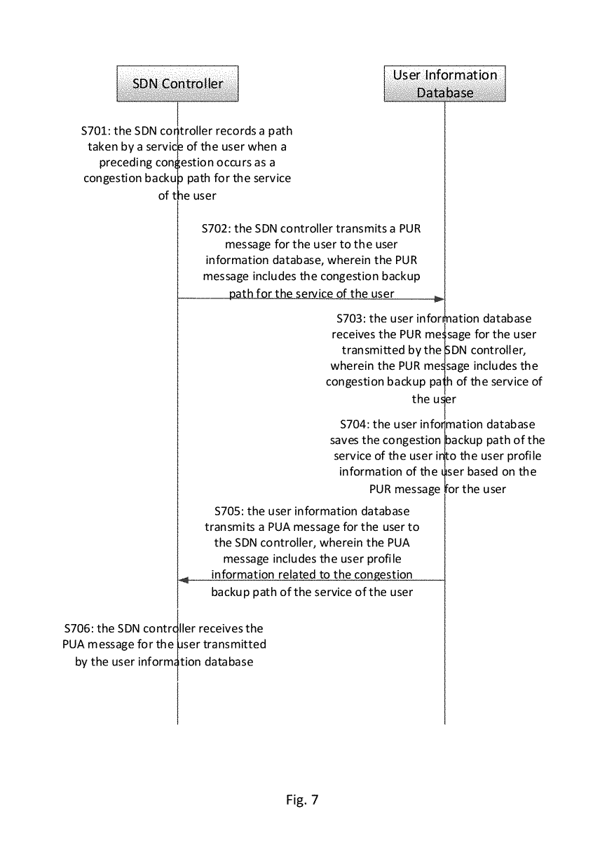

FIG. 7 shows a message interaction diagram of a congestion backup path for communication between the SDN controller and the user information database to update user service according to one preferred embodiment of the present invention;

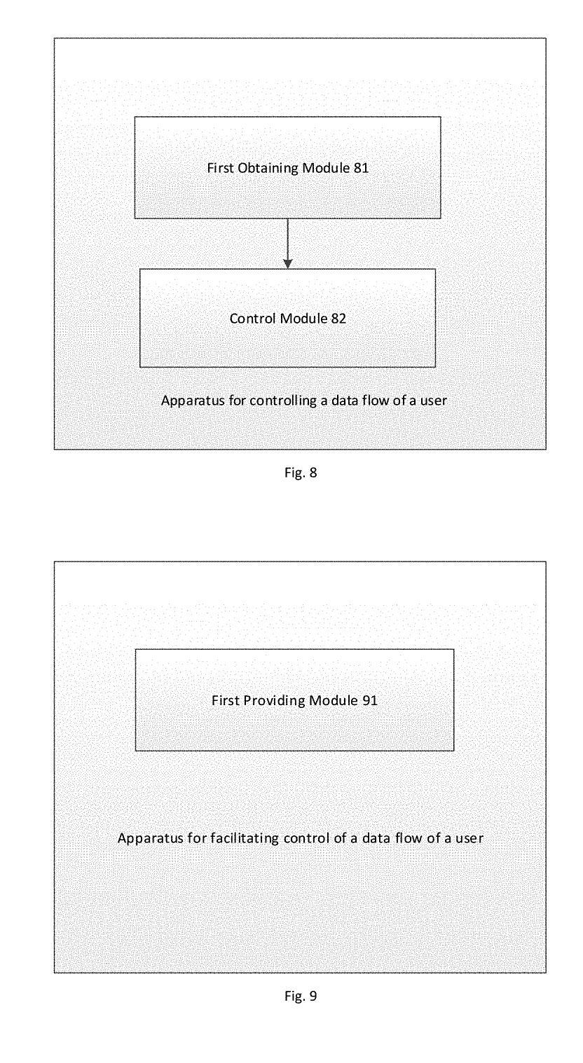

FIG. 8 shows a schematic diagram of an apparatus for controlling a user data flow at an SDN controller in an SDN network according to one aspect of the present invention;

FIG. 9 shows a schematic diagram of an apparatus for facilitating control of a user data flow in a user information database of an SDN network according to another aspect of the present invention.

It should be noted that these accompanying drawings intend to illustrate general features of a method, structure and/or material as utilized in some exemplary embodiments, and supplement the literal depiction provided infra. However, these figures are not drawn proportionally and possibly do not accurately reflect an accurate structure or performance feature of any given embodiment; besides, they should be construed as defining or limiting the scope of numerical values or attributes covered by exemplary embodiments. In respective drawings, similar or completely identical reference numerals in respective figures are for indicating existence of similar or completely identical units or features.

### DETAILED DESCRIPTION OF THE PREFERRED EMBODIMENTS

Although the exemplary embodiments may have a plurality of modifications and replacement forms, some embodiments therein are illustrated in the accompanying drawings in an exemplary manner, which will be described in detail here. However, it should be understood that the exemplary embodiments are not intended to limit the exemplary embodiments to the specific manner as disclosed. On the contrary, the exemplary embodiments intend to cover all modifications, equivalent solutions, and replacement solutions within the scope of the claims. The same reference numerals constantly refer to same units in depiction of respective drawings.

Before discussing the exemplary embodiments in more detail, it should be noted that some exemplary embodiments are described as a processing or method depicted in the flow diagrams. Although the flow diagrams describe various operations as a sequential processing, many operations therein may be implemented in parallel, concurrently, or simultaneously. Besides, the sequence of various operations may be re-arranged. When their operations are completed, the processing may be terminated; but there may also comprise additional steps not included in the drawings. The processing may correspond to a method, function, routine, sub-routine, sub-program, etc.

The term “wireless device” or “device” used here may be regarded as synonymous to and sometimes may be referred to respective items of the following: client, user equipment, mobile station, mobile user, mobile terminal, subscriber, user, remote station, access terminal, receiver, and a mobile unit, etc., and may describe a remote user of a radio resource in a wireless communication network.

Similarly, the term “base station” used here may be regarded as synonymous to and sometimes may be referred to respective items of the following: node B, evolved-type node B, eNodeB, transceiver base station (BTS), RNC, etc., and may be described as a transceiver that may communicate with the mobile terminal and provide radio resources therefore in a wireless communication network across a plurality of technical generations. Besides the capability of implementing the method discussed here, the base station as discussed may have all functions associated with conventional well-known base stations.

The methods discussed hereinafter (some of them are illustrated through flow diagrams) may be implemented by hardware, software, firmware, middleware, microcode, hardware description language or any combination thereof. When they are implemented by software, firmware, middleware or microcode, the program code or code segment for implementing essential tasks may be stored in a machine or computer readable medium (e.g., storage medium). (One or more) processors may implement essential tasks.

The specific structure and functional details as disclosed here are only representative for the purpose of describing the exemplary embodiments of the present invention. However, the present invention may be specifically implemented through many alternative manners, and should not be construed as being only limited to the embodiments illustrated herein.

It should be understood that although terms “first” and “second” are used to describe respective units, these units should not be limited by these terms. Use of these terms is only for distinguishing one unit from another unit. For example, without departing from the scope of the exemplary embodiments, a first unit may be referred to a second unit, and similarly, a second unit may also be referred to as a first unit. The term “and/or” used here include any and all combinations of one or more associated items.

It should be understood that when one unit is described as “connected to” or “coupled to” a further unit, it may be directly connected or coupled to the further unit; or there may exist an intermediate unit. In contrast, when one unit is described as “directly connected to” or “directly coupled to” a further unit, there does not exist an intermediate unit. Other words used for describing a relationship between units should be construed in a similar manner (e.g., “disposed between” VS. “directly disposed between,” “adjacent to . . . ” VS “immediately adjacent to . . . ,” etc.).

The term used here is only for describing preferred embodiments, but intended to limit the exemplary embodiments. Unless otherwise indicated in the context, the singular form “a”, “an” used here is also intended to include plurality. It should also be understood that the term “comprise” and/or “include” used here prescribes existence of the stated feature, integer, step, operation, unit and/or component, without excluding existence or addition of one or more other features, integers, steps, operations, units, components, and/or a combination thereof.

It should also be noted that in some alternative embodiments, the function/action as mentioned may occur in a sequence different from what is annotated in the drawings. For example, dependent on the functions/actions as involved, successively illustrated two figures actually may be simultaneously implemented substantially or sometimes may be performed in a reverse order.

Unless otherwise defined, all terms used here (including technical and scientific terms) have the same meaning as generally understood by those skilled in the art. It should also be understood that unless explicitly defined here those terms (e.g., defined in common dictionaries) should be construed with meanings consistent with their meanings in a context in relevant fields, but should not be construed with ideal or too formal meanings.

Some parts of the exemplary embodiments and corresponding detailed description are provided through software or algorithm as well as symbolic expressions for operating data bits within a computer memory. These description and expressions are descriptions and expressions of a person skilled in the art to effectively convey its work essence to other terminal person in the art. As used in general, the term “algorithm” used here is envisaged as a step sequence consistent with the desired result. The steps refer to those steps that need to perform physical manipulation of the physical amount. Generally, but not essentially, these numbers may assume optical, electrical, or magnetic signal forms that can be stored, transmitted, combined, compared and manipulated according to other manner. Mainly out of the reason for general use, it has been proved that sometimes, it is convenient that these signals are referred to as bits, numbers, elements, symbols, characters, items, digits, etc.

The description hereinafter will refer to symbolic expressions (e.g., in the form of a flow diagram) that may be implemented as actions and operations of a program module or functional processing so as to describe illustrative embodiments. The program module or function processing include a routine, program, object, assembly, data structure for implementing a specific task or implementing a specific abstract data type, and may be implemented using existing hardware at existing network element. Such existing hardware may comprise one or more central processing units (CPU), digital signal processor (DSP), an application-specific integrated circuit, a field programmable gate array (FPGA) computer, etc.

However, it should be aware that all of these and similar terms should be associated with appropriate physical amounts, and are only convenient tags applied to these numbers. Unless otherwise stated or apparently seen from the discussion, terms such as “processing,” “computing,” “determining” or “displaying” refer to actions and processing of a computer system or a similar electronic computing device, which manipulates the data representing physical and electronic data within the register and memory of the computer system, which data are converted into other data similarly represented as physical numbers within the computer system memory or register or other similar kind of information storing, transmitting or displaying device.

It should also be noted that aspects of software implementation of the exemplary embodiments are generally implemented by being encoded on a certain form of program storage medium or through a certain type of transmit medium. The program storage medium may be magnetic (e.g., soft disk or hard disk driver) or optical (e.g., compact disk read-only memory or “CD-ROM”) storage medium, and may also be a read-only or random access storage medium. Similarly, the transmit mediums may be twisted-pair cable, Co.-axial cable, optical fiber, or some other appropriate transmit mediums known in the art. The exemplary embodiments are not limited by such aspect of any given embodiment.

The processor and memory may operate together to run an apparatus function. For example, the memory may store code segments regarding an apparatus function. The code segment may also be executed by the processor. Besides, the memory may store processing variables and constants for the processor to use.

Hereinafter, the present invention will be described in further detail with reference to the accompanying drawings.

FIG. 1 shows a schematic diagram of SDN network architecture. The SDN is a new type of network structure, which realizes flexible control of network service by decoupling a control plane from a data forwarding plane of the network. The SDN network architecture is divided into a data layer, a control layer, and an application layer. The data layer mainly performs a function of data forwarding; the application layer transmits a request through an interface of the control layer, while the SDN control layer initiates a corresponding data layer processing resource after accepting an application request of the application layer so as to accomplish an application response. At the convenience of reading, hereinafter, the SDN network and its components as shown in FIG. 1 will be taken as an example to describe the embodiments of the present invention. In the SDN network architecture diagram in FIG. 1, a service enabler, as a data processing resource for the SDN, completes data processing and data forwarding of the user data flow. An SDN controller, as a centralized control unit in the SDN network, performs data processing and data forwarding of the user data flow via an interface protocol control Enabler. A user information database is an infrastructure network element device for implementing a uniform account service of a telecommunication carrier, which stores user profile information. The user information database, for example, may be UDB (User Database) or SPR (Subscriber Profile Repository).

In the current SDN network architecture; there is no interface for transmitting user profile information between the SDN controller and the user information database. If the SDN controller may control a user data flow based on the user profile information, some customized services may be provided to the user, and a flexible control policy may be implemented to the service based on the user profile, thereby enhancing user experience. In order to solve the above technical problem, as one of the objectives of the present invention, the present invention newly adds an interface between the SDN controller and the user information database. At the convenience of reading, the newly added interface is referred to as an Ss interface. The Ss interface is for communication between the SDN controller and the user information database.

It should be noted that relevant depictions of the SDN network architecture, SDN controller, and user information database are only examples, and other existing or future possibly evolved SDN network architecture, SDN controller, and user information database, if applicable to the present invention, should also be included within the protection scope of the present invention, and is thus incorporated here by reference.

FIG. 2 shows a flow diagram of a method for controlling a user data flow at an SDN controller in an SDN network. In this embodiment, there comprises step S21 and step S22.

In step S21, the SDN controller obtains user profile information from a user information database via an Ss interface with the user information database.

As mentioned above, a new interface is introduced between the SDN controller and the user information database. At the ease of reading, it is herein referred to as an Ss interface. The Ss interface is for communication between the SDN controller and the user information database, e.g., the SDN controller may obtain the user profile information from the user information database via the Ss interface. In a preferred embodiment, the Ss interface is used for the communication objective between the SDN controller and the user information database based on a Diameter protocol in conjunction with a newly added Diameter message.

In the present invention, the user profile information refers to any information related to the user. In one embodiment, the user profile information includes at least one of the following:

user identity identification;

user priority;

user subscribed service;

user QoS demand;

congestion backup path for user service.

Here, the user identity identification refers to identification information for distinguishing subscriber identity in an SDN network, e.g., user ID. The user priority refers to for example user importance level, user type, etc., which is a priority level determined for a user based on the user's application scenario, user consumption information, and the user's online history information, and the like, e.g., VIP (Very Important Person) user, common user, low priority user, etc. Generally, the data flow of a user with a higher importance level should be served in priority.

The user subscribed service refers to a service that has been applied and purchased by the use, e.g., e-mail service, or YouTube video watching service, etc. The user QoS demand refers to the user's service quality demand for the subscribed service. For example, the user purchases the YouTube video watching service, and the user may designate that the service's QoS demand as the highest service quality level, such that when the user uses YouTube video watching service, it should be controlled to maintain the connection to the service as much as possible. The congestion backup path for user service means a backup path that may be selected by the SDN controller for transmitting a user service data flow when congestion occurs in the network, so as to avoid congestion as much as possible.

Those skilled in the art should understand that relevant description of the user profile information is only an exemplary, not limitative depiction, and there exist various other implementation manners without departing from the spirit or scope of the present invention, which are incorporated here by reference.

Specifically, in step S21, the SDN controller may obtain the user profile information from the user information database via an Ss interface. For example, the SDN controller may communicate with the user information database via an Ss interface, thereby obtaining the user profile information of one or more users. In one embodiment, when the user initially accesses, the SDN controller may obtain the user's user profile information. Hereinafter, FIG. 4 will be referenced to further describe the embodiment. In a further embodiment, when the user requests for using the service, the SDN controller retrieves the user profile information from the user information database based on the user's request for using the service. Hereinafter, the embodiment will be further described with reference to FIG. 5. In a still further embodiment, when the user requests for adding a new service, the SDN controller will interact with the user database based on the user's request for adding a new service, so as to update the user profile information. Hereinafter, FIG. 6 will be referenced to further describe the embodiment.

Next, in step S22, the SDN controller controls the user's data flow based on the user profile information. The controlling includes, but not limited to:

route selection

permission control.

Route selection refers to the SDN controller allocates an appropriate route for the user's data flow. The SDN controller may control the user's data flow based on the user profile information. For example, the SDN controller obtains the user profile information from the user information database, thereby obtaining the user priority, user subscription service, and user QoS demand. Then, the SDN controller may determine the bandwidth needed by the service subscribed by the user based on the user subscription service and the user QoS demand. Next, the SDN controller may determine the bandwidth needed by the service purchased by the user based on the user subscribed service and the user QoS need. Next, the SDN controller may allocate a route satisfying the user service, user QoS demand, and user priority demand to the user based on the user priority and the load of the service processing unit Enablers of the data plane. For example, if the subscriber A purchases the YouTube video watching service, the QoS demand is the highest service quality, then the user A is a VIP user. The SDN controller determines the bandwidth needed by the user when serving the YouTube video watching service based on the YouTube video watching service and the QoS demand. Because the current user is a VIP user, the SDN controller selects a path with the lightest load for the user, which may satisfy the bandwidth requirement of smooth watching of the YouTube video watching service. In the case of network congestion, the SDN controller may also adjust the service data route of a low priority user, so as to satisfy the demand of the high priority users.

In one embodiment, the SDN controller determines a route of the data flow of the service subscribed by the user based on the user profile information already obtained from the user information database. Then, the SDN controller may transmit the route information to the SDN Enablers, such that when the user requests for the service, the SDN Enablers may correspondingly control the user's data flow based on the route determined by the SDN controller.

In another embodiment, the SDN controller may also dynamically determine a route of the user data flow based on the user profile information. For example, when the network congestion occurs, the SDN controller may select other appropriate route for the service subscribed for the user based on the user profile and notifies the SDN enablers to update the route.

For example, user A is a VIP user of the game Dota2. The user wishes a highest QoS level such that the data flow to the server of the game Dota2 can maintain connected. The SDN controller obtains the user profile information of user A from the user information database, including a suggested backup path for the Dota2 data flow when the congestion occurs, e.g., the path from Enabler 1 to Enabler 4. When the network condition is good, the SDN controller selects a path for the user data flow according to a given policy, e.g., the path from Enabler 1 to Enabler 3. When the network congestion occurs, the SDN controller knows the user A wishes the highest QoS level to maintain being connected to the game Dota2 server according to the user profile information of user A; therefore, the SDN controller first tries the path from Enabler 1 to Enabler 4 according to the above indication of the congestion backup path. If the congestion alternative path does not meet the requirement, the SDN controller will search for other possible paths, e.g., the path from Enabler 1 to Enabler 5. Meanwhile, the SDN controller notifies the user information database to update the congestion alternative path of the service from user A to Dota2 into from Enabler 1 to Enabler 5.

Those skilled in the art should understand that relevant description of the route selection is only exemplary, not limitative description. Various other embodiments exist without departing from the spirit or scope of the present invention, which are incorporated here by reference.

Permission control means the SDN controller determines whether to allow or stop the data flow of the user based on the user profile, e.g., the service subscribed by the user. For example, the user may subscribe for a Child Internet Access Control service. Once the user subscribes for the service, the SDN controller will notify the Enablers to reject transmitting the data flow for the user connected to the Dota2 game server to the Dota2 game server via an SDN network. For another example, the SDN controller may also perform permission control in conjunction with the user subscribed service and the current time period. Continue with the above example, the user may apply to set subscribing the Child Internet Access Control service during a period of time from 6:00 pm to 6:00 am, while in other period of time, cancelling subscribing the Child Internet Access Control service. Once the user is connecting to the Dota2 game server within the period of time from 6:00 pm to 6:00 am, the SDN controller will reject the data flow of the user connected to the Dota2 game server from being transmitted to the Dota2 game server via the SDN network.

Those skilled in the art should understand that relevant description of permission control is only exemplary, not limitative description; various other embodiments exist without departing from the spirit or scope of the present invention, which are incorporated here by reference.

FIG. 3 shows a flow diagram of a method for facilitating control of user data flow in a user information database in an SDN network according to an embodiment of another aspect of the present invention, wherein the method comprises step S31.

In step S31, the user information database provides user profile information to an SDN controller via an Ss interface with the SDN controller. For example, the user information database may perform a match query so as to obtain profile information of one or more users needed by the SDN controller, and then transmits to the SDN controller via the Ss interface. In one embodiment, when the user initially accesses, the user information database will transmit the user profile information of the user to the SDN controller via the Ss interface, which will be further described with reference to FIG. 4 hereinafter. In a further embodiment, when the user requests for using the service, the user information database transmits the user profile information of the user to the SDN controller via the Ss interface based on the request of the SDN controller, which will be further described with reference to FIG. 5. In a still further embodiment, when the user requests for adding a new service, the user information database will update the user profile request information to the SDN controller based on the information transmitted based on the SDN controller, which will be further described with reference to FIG. 6.

FIG. 4 shows a message interacting diagram for communication between the SDN controller and the user information database when the user initially accesses in one preferred embodiment of the present invention.

First, in step S401, when the user initially accesses, the user information database transmits a user profile information download notification message of the user to the SDN controller, wherein the user profile information download notification message includes the user profile information of the user. At the ease of reading, the user profile information download notification message will be shortly referred to as a PDN message, i.e., a Profile-Download-Notify message. Here, the user may access to the SDN network by for example turning on a mobile terminal. Because those skilled in the art already know the technology of user initial access, it will not be detailed here. When the user information database obtains the user initial access, the user information database queries the user profile information of the user to include the user profile information of the user in the PDN message, and the PDN message is transmitted to the SDN controller via the Ss interface. Hereinafter, as a specific example of the PDN message, the PDN message includes, but not limited to the following information:

Profile-Download-Notify (PDN):

user identity identification;

SDN controller identification;

user subscribed service;

user priority;

user QoS demand;

congestion backup path of a user service.

Then, in step S402, the SDN controller receives the user profile information download notification message of the user as transmitted by the user information database. For example, the SDN controller may receive the PDN message transmitted by the user information database based on event trigger or periodically through the Ss interface. As mentioned above, the PDN message includes the user profile information of the user.

Next, in step S403, the SDN controller obtains the user profile information of the user based on the PDN message. For example, after the SDN controller receives the PDN message via the Ss interface, the SDN controller may identify whether it belongs to its own to-be-processed message based on the SDN controller identification included in the message, and then extracts the user profile information for the user from the PDN message. The SDN controller may also store the user profile information of the user locally so as to avoid repetitively querying the user profile information of the user to the user information database.

Next, in step S404, the SDN controller transmits the user profile information download report message for the user to the user information database via the Ss interface with the user information database based on the result of obtaining the user profile information of the user. At the ease of reading, the user profile information download report message is simply referred to as PDR, i.e., Profile Download Report message. The PDR message may include whether the above PDN message is successfully received by the SDN controller as mentioned above, i.e., whether the SDN controller has successfully retrieved the indication information of the user profile information of the user. If the PDN controller fails to retrieve the user profile information of the user from the PDN message, the SDN controller may also comprise information such as failure cause in the PDR message. A specific example of the PDR message is provided below, wherein the PDR message includes, but not limited to, the following information:

Profile-Download-Report (PDR):

user identity identification;

SDN controller identification;

PDN receive success or failure;

when receive fails, also include the failure cause.

In step S405, the SDN controller controls the user's data flow based on the obtained user profile information. For example, the SDN controller may perform route selection to the user's data flow according to the manner described in step S22 above, e.g., allocating appropriate Enablers for the user's service data flow.

The following is an example of the processing procedure of the SDN controller and the user information database during the user's initial access process. In the example, user A registers the e-mail service, user A is a VIP user. When user A accesses a network, the user information database will transmit user A's user profile information to the SDN controller via the Ss interface, and the SDN controller receives and stores the user A's user profile information in the SDN controller. Then, the SDN controller understands that user A subscribes an e-mail service based on user A's user profile information, and the SDN controller will allocate Enablers suitable to be sent by the e-mail service for user A. For example, Enabler 1, Enabler 5, Enabler 6 are all suitable for e-mail service transmission; the SDN controller selects Enabler 5 with the lightest service load based on the user A's priority being VIP so as to transmit the e-mail service for user A.

FIG. 5 shows a message interaction diagram for communication between an SDN controller and the user information database when the user performs service application in a preferred embodiment of the present invention.

First, in step S501, when the user initiates a service request, the SDN controller transmits the user profile information query message for the user to the user information database via an Ss interface with the user information database. At the ease of reading, the user profile information query request message will be shortly referred to as PQR, i.e., Profile-Query-Request message. Here, the user may initiate a service request through a user equipment, e.g., via a mobile terminal. Because those skilled in the art known the technology of the user service request process, it will not be detailed here. After the SDN controller knows the user's service request information, the SDN controller transmits a PQR message to the user information database via the Ss interface, the PQR message including the user identity identification and an indication of the user profile information needed by the SDN controller. In a preferred embodiment, after the SDN controller obtains the user's service request information, the user profile information of the user is searched locally at the SDN controller based on the user identity identification included in the request. When the SDN controller cannot locally find the latest user profile information of the user, the SDN controller transmits a PQR message to the user information database via the Ss interface so as to request for the user profile information of the user.

Hereinafter, a specific example of the PQR message is shown, wherein the PQR message includes, but not limited to, the following information:

PQR (Profile-Query-Request):

user identity identification;

SDN controller identification;

user profile information needed by the SDN controller;

user priority;

congestion backup path;

other needed information.

Next, in step S502, the user information database receives the user profile information query request message for the user transmitted by the SDN controller via an Ss interface with the SDN controller. For example, the user information database may receive the PQR message transmitted by the SDN controller based on event-trigger or periodically via the Ss interface. As mentioned above, in the PQR message, there includes a user identity identification and an indication of the user profile information needed by the SDN controller, etc.

Next, in step S503, the user information database performs query based on the user profile information query request message for the user to obtain the user profile information of the user. For example, after receiving the PQR message via an Ss interface, the user information database may query the profile information of the user based on the user identity identification included in the message, and then finds the content items of the user profile information needed by the SDN controller from the user profile information.

Next, in step S504, the user information database transmits the user profile information query answer message for the user to the SDN controller via an Ss interface with the SDN controller, wherein the user profile information query answer message includes the user profile information of the user. At the ease of reading, the user profile information query answer message is simply referred to as PQA, i.e., Profile-Query-Answer message. The PQA message refers to the answer of the user information database to the PQR request message transmitted by the SDN controller, including an indication for answering whether the PQR request succeeds or fails. If the user information database successfully queries the profile information of the user, the user information database indicates that the request succeeds in the PQA message, and includes, in the message, the content of the user profile information applied by the user; if the user information database fails to query the profile information of the user, the user information database indicates a failure request in the PQA message, and provides information such as the cause of the failure or the next action suggestion. Hereinafter, a specific example of the PQA message is provided, wherein the PQA message includes, but not limited to, the following information:

PQA (Profile-Query-Answer):

request confirmation indication, success or failure;

if the request succeeds, provide the user profile information of the user;

if the request fails, provide the cause of failure or the next step of action, etc.

In step S505, the SDN controller receives the user profile information query answer message for the user transmitted by the user information database. For example, the SDN controller may receive the PQA message transmitted by the user information database based on event trigger or periodically via the Ss interface. As mentioned above, in the PQA message, there includes the user profile information requested by the SDN controller.

In step S506, the SDN controller obtains the user profile information of the user based on the user profile information query answer message for the user. For example, the SDN controller obtains the content of the user profile information of the user in the PQA message based on the PQA message and saves the content of the user profile information of the user locally.

In step S507, the SDN controller controls the user's data flow based on the obtained user profile information. For example, the SDN controller may perform route selection of the user's data flow according to the manner described in step S22, e.g., allocating appropriate Enablers for the user's service data flow.

Hereinafter, during the user's service request process, an example of the SDN controller and the user information database processing procedure is provided. User A registers the e-mail service, while user A is a VIP user. When the user A initiates an e-mail service request, the SDN controller will receive information about user A's service request. The SDN controller queries the user profile information of the user A. If the SDN controller does not have the user profile information or the latest user profile information of the user A, the SDN controller transmits a PQR message to the user information database. After receiving the PQR message, the user information database queries to obtain the user profile information of the user A, transmits it to the SDN controller via the PQA message, and stores it in the SDN controller. The SDN controller understands that the user A has subscribed for the e-mail service based on the user profile information of the user A, and the SDN controller will allocate Enablers suitable for e-mail service transmission for the user A's e-mail service data flow. For example, Enabler 1, Enabler 5 and Enabler 6 are all suitable for e-mail service transmission; the SDN controller selects Enabler 5 with the lightest service load for the user A to transmit the e-mail service based on the user A's priority.

FIG. 6 shows a message interaction diagram for communication between the SDN controller and the user information database when the user registers a new service in one preferred embodiment of the present invention.

First, in step S601, when the user registers a new service, the SDN controller transmits the user profile information update request message for the user to the user information database via an Ss interface with the user information database based on the user's request for adding a new service, wherein the user profile information update request message includes information of the new service the user requests to add. At the ease of reading, the user profile information update request message is shortly referred to as PUR, i.e., Profile-Update-Request message. Here, the user may initiate a new service registration request through the user equipment, e.g., the mobile terminal. Because those skilled in the art have known the technology of the user new service registration request procedure, it will not be detailed here. After the SDN controller knows the user's new service registration request information, it transmits a PUR message to the user information database based on the type of the service newly registered included in the request. The PUR message includes the service information newly registered by the user:

PUR (Profile-Update-Request):

user identity identification;

SDN controller identification;

information of service newly registered by the user.

Then, in step S602, the user information database receives the user profile information update request message for the user transmitted by the SDN controller via an Ss interface with the SDN controller, wherein the user profile information update request message includes the information of a new service the user requests to add. For example, the user information database may receive the PUR message transmitted by the SDN controller based on event trigger or periodically via the Ss interface. As mentioned above, the PUR message includes information of the new service the user requests to add.

Next, in step S603, the user information database determines the user profile information related to the new service the user requests to add based on the user profile information update request message for the user. For example, after receiving the PUR message via the Ss interface, the user information database may determine information related to the new service the user requests to add, e.g., whether the user successfully subscribes the service, charging information, etc., and saves the information in the user's user profile information.

Next, in step S604, the user information database transmits the user profile information update answer message for the user to the SDN controller via an Ss interface with the SDN controller, wherein the user profile information update answer message includes the user profile information related to the new service. At the ease of reading, the user property information update answer message is shortly referred to as PUA, i.e., Profile-Update-Answer message. The PUA message is an answer message of the user information database to the PUR request message transmitted by the SDN controller, wherein it may be included in the user profile information related to the new service as determined in step S603. Besides, the PUA message may also include an indication of answering to whether the PUR request succeeds or fails. If the user information database successfully updates the user profile information, the user information database transmits an indication of confirming success in the PUA message; if the user information database fails to successfully update the user profile information, the user information database provides information such as the cause of failure or the next action suggestion in the PUA message. Hereinafter, a specific example of the PUA message is provided, wherein the PUA message includes, but not limited to the following information:

PUA (Profile-Update-Answer):

user profile information related to the new service;

confirming update success or failure;

in the case of failure, providing the cause of failure and the next step of action, etc.

In step S605, the SDN controller receives the user profile information update answer message for the user transmitted by the user information database via an Ss interface with the user information database, wherein the user profile information update answer message includes user profile information related to the new service. For example, the SDN controller may receive the PUA message transmitted by the user information database based on event trigger or periodically via the Ss interface. As mentioned above, the PUA message includes the user profile information related to the new service.

In step S606, the SDN controller updates the user profile information of the user based on the user profile information update answer message for the user. For example, the SDN controller may obtain the user profile information of the user related to the new service from the PUA message after receiving the PUA message via an Ss interface. The SDN controller may save the information in the SDN controller locally.

In step S607, the SDN controller controls the user's data flow based on the obtained user profile information. For example, the SDN controller may perform route selection to the user's data flow according to the manner described above in step S22, e.g., allocating appropriate Enablers for the user's service data flow.

Hereinafter, an example of SDN controller and user information database processing procedure is provided during the process of the user's new service registration. In the present example, the user A has previously accessed the network and has registered the e-mail service. The user A wants to register a new service, e.g., a YouTube video watching service. The user A transmits a request for registering the YouTube video watching service to the SDN network. The SDN controller receives the information about the user A's request for registering the YouTube video watching service; the SDN controller transmits the user A's information of the newly added request to the user information database via the PUR message. After receiving the PUR message, the user information database adds, in the user A's profile information, YouTube video watching service-related user profile information, e.g., its charging information, and transmits the PUA message to the SDN controller, and includes the user A's user profile information related to YouTube video watching service in the PUA message. After receiving the PUA message, the SDN controller obtains user A's user profile information related to YouTube video watching service therefrom and updates the locally stored user profile information of the user A. Finally, the SDN controller determines a route and notifies it to appropriate Enablers for user A's YouTube video watching service data flow based on the latest user profile information of the user A.

FIG. 7 shows a message interaction diagram of a congestion backup path for communication between the SDN controller and the user information database to update user service according to one preferred embodiment of the present invention.

In step S701, the SDN controller records a path taken by a service of the user when a preceding congestion occurs as a congestion backup path for the service of the user. For example, when congestion occurs, the SDN controller will select other available path for the service of the user, and takes the path as the congestion backup path of the service of the user, and records it locally.

In step S702, the SDN controller transmits the user profile information update request message for the user to the user information database via an Ss interface with the user information database, wherein the user profile information update request message includes a congestion backup path for the service of the user.

In step S703, the user information database receives the user profile information update request message for the user transmitted by the SDN controller via an Ss interface with the SDN controller, wherein the user profile information update request message includes a congestion backup path of the service of the user. For example, the user information database may receive the PUR message transmitted by the SDN controller based on event trigger or periodically through the Ss interface. As mentioned above, in the PUR message, there includes information regarding a congestion backup path of the user's service.

In step S704, the user information database saves the congestion backup path of the user's service into the user profile information of the user based on the user profile information update request message for the user. For example, after receiving the PUR message via the Ss interface, the user information database may retrieve information regarding the congestion backup path of the user's service, and saves the information in the user profile information of the user.

Next, in step S705, the user information database transmits the user profile information update answer message for the user to the SDN controller via an Ss interface with the SDN controller, wherein the user profile information update answer message includes the user profile information related to a congestion backup path of the user's service.

In step S706, the SDN controller receives the user profile information update answer message for the user transmitted by the user information database via an Ss interface with the user information database, wherein the user profile information update response message includes the user profile information related to the congestion alternative path of the user's service. For example, the SDN controller may receive the PUA message transmitted by the user information database based on event trigger or periodically via the Ss interface.

FIG. 8 shows a schematic diagram of an apparatus for controlling a user data flow in an SDN controller in an SDN network. As shown in FIG. 8, the apparatus for controlling a user data flow in an SDN controller in an SDN network comprises a module 81 configured to obtain user profile information from a user information database via an Ss interface with the user information database, hereafter referred to as a first obtaining module 81; a module 82 configured to control a data flow of a user based on the user profile information, hereafter referred to as control module 82.

Firstly, the first obtaining module 81 of the SDN controller obtains user profile information from a user information database via an Ss interface with the user information database.

As mentioned above, a new interface is introduced between the SDN controller and the user information database. At the ease of reading, it is herein referred to as an Ss interface. The Ss interface is for communication between the SDN controller and the user information database, e.g., the SDN controller may obtain the user profile information from the user information database via the Ss interface. In a preferred embodiment, the Ss interface is used for the communication objective between the SDN controller and the user information database based on a Diameter protocol in conjunction with a newly added Diameter message.

In the present invention, the user profile information refers to any information related to the user. In one embodiment, the user profile information includes at least one of the following:

user identity identification;

user priority;

user subscribed service;

user QoS demand;

congestion backup path for a service of a user.

Here, the user identity identification refers to identification information for distinguishing subscriber identity in an SDN network, e.g., user ID. The user priority refers to for example user importance level, user type, etc., which is a priority level determined for a user based on the user's application scenario, user consumption information, and the user's online history information, and the like, e.g., VIP (Very Important Person) user, common user, low priority user, etc. Generally, the data flow of a user with a higher importance level should be served in priority. The user subscribed service refers to a service that has been applied and purchased by the use, e.g., e-mail service, or YouTube video watching service, etc. The user QoS demand refers to the user's service quality demand for the subscribed service. For example, the user purchases the YouTube video watching service, and the user may designate that the service's QoS demand as the highest service quality level, such that when the user uses YouTube video watching service, it should be controlled to maintain the connection to the service as much as possible. The congestion backup path for user service means a backup path that may be selected by the SDN controller for transmitting a user service data flow when congestion occurs in the network, so as to avoid congestion as much as possible.

Those skilled in the art should understand that relevant description of the user profile information is only an exemplary, not limitative depiction, and there exist various other implementation manners without departing from the spirit or scope of the present invention, which are incorporated here by reference.

Specifically, the first obtaining module 81 of the SDN controller may obtain the user profile information from the user information database via an Ss interface. For example, the first obtaining module 81 of the SDN controller may communicate with the user information database via an Ss interface, thereby obtaining the user profile information of one or more users. In one embodiment, when the user initially accesses, the first obtaining module 81 of the SDN controller may obtain the user's user profile information. Hereinafter, FIG. 4 will be referenced to further describe the embodiment. In a further embodiment, when the user requests for using the service, the first obtaining module 81 of the SDN controller retrieves the user profile information from the user information database based on the user's request for using the service. Hereinafter, the embodiment will be further described with reference to FIG. 5. In a still further embodiment, when the user requests for adding a new service, the first obtaining module 81 of the SDN controller will interact with the user database based on the user's request for adding a new service, so as to update the user profile information. Hereinafter, FIG. 6 will be referenced to further describe the embodiment.

Next, the control module 82 of the SDN controller controls the user's data flow based on the user profile information. The control includes, but not limited to:

route selection

permission control.

Route selection refers to the SDN controller allocates an appropriate route for the user's data flow. The control module 82 may control the user's data flow based on the user profile information. For example, the first obtaining module 81 obtains the user profile information from the user information database, thereby obtaining the user priority, user subscription service, and user QoS demand. Then, the control module 82 may determine the bandwidth needed by the service subscribed by the user based on the user subscription service and the user QoS demand. Next, the control module 82 may determine the bandwidth needed by the service purchased by the user based on the user subscribed service and the user QoS need. Next, the control module 82 may allocate a route satisfying the user service, user QoS demand, and user priority demand to the user based on the user priority and the load of the service processing unit Enablers of the data plane. For example, if the subscriber A purchases the YouTube video watching service, the QoS demand is the highest service quality, then the user A is a VIP user. The control module 82 determines the bandwidth needed by the user when serving the YouTube video watching service based on the YouTube video watching service and the QoS demand. Because the current user is a VIP user, the SDN controller selects a path with the lightest load for the user, which may satisfy the bandwidth requirement of smooth watching of the YouTube video watching service. In the case of network congestion, the control module 82 may also adjust the service data route of a low priority user, so as to satisfy the demand of the high priority users.

In one embodiment, the control module 82 determines a route of the data flow of the service subscribed by the user based on the user profile information already obtained from the user information database. Then, the control module 82 may transmit the route information to the SDN Enablers, such that when the user requests for the service, the SDN Enablers may correspondingly control the user's data flow based on the route determined by the control module 82.

In another embodiment, the control module 82 may also dynamically determine a route of the user data flow based on the user profile information. For example, when the network congestion occurs, the control module 82 may select other appropriate route for the service subscribed for the user based on the user profile and notifies the SDN enablers to update the route.

For example, user A is a VIP user of the game Dota2. The user wishes a highest QoS level such that the data flow to the server of the game Dota2 can maintain connected. The first obtaining module 81 obtains the user profile information of user A from the user information database, including a suggested backup path for the Dota2 data flow when the congestion occurs, e.g., the path from Enabler 1 to Enabler 4. When the network condition is good, the control module 82 selects a path for the user data flow according to a given policy, e.g., the path from Enabler 1 to Enabler 3. When the network congestion occurs, the control module 82 knows the user A wishes the highest QoS level to maintain being connected to the game Dota2 server according to the user profile information of user A; therefore, the control module 82 first tries the path from Enabler 1 to Enabler 4 according to the above indication of the congestion backup path. If the congestion alternative path does not meet the requirement, the control module 82 will search for other possible paths, e.g., the path from Enabler 1 to Enabler 5. Meanwhile, the control module 82 notifies the user information database to update the congestion alternative path of the service from user A to Dota2 into from Enabler 1 to Enabler 5.

Those skilled in the art should understand that relevant description of the route selection is only exemplary, not limitative description. Various other embodiments exist without departing from the spirit or scope of the present invention, which are incorporated here by reference.

Permission control means the control module 82 determines whether to allow or stop the data flow of the user based on the user profile, e.g., the service subscribed by the user. For example, the user may subscribe for a Child Internet Access Control service. Once the user subscribes for the service, the control module 82 will notify the Enablers to reject transmitting the data flow for the user connected to the Dota2 game server to the Dota2 game server via an SDN network. For another example, the control module 82 may also perform permission control in conjunction with the user subscribed service and the current time period. Continue with the above example, the user may apply to set subscribing the Child Internet Access Control service during a period of time from 6:00 pm to 6:00 am, while in other period of time, cancelling subscribing the Child Internet Access Control service. Once the user is connecting to the Dota2 game server within the period of time from 6:00 pm to 6:00 am, the control module 82 will reject the data flow of the user connected to the Dota2 game server from being transmitted to the Dota2 game server via the SDN network.

Those skilled in the art should understand that relevant description of permission control is only exemplary, not limitative description; various other embodiments exist without departing from the spirit or scope of the present invention, which are incorporated here by reference.

FIG. 9 shows a schematic diagram of an apparatus for facilitating control of user data flow in a user information database in an SDN network according to an embodiment of another aspect of the present invention. As shown in FIG. 9, the apparatus comprises a module 91 configured to provide a user profile information to an SDN controller via an Ss interface with the SDN controller, hereafter referred to as a first providing module 91.

The first providing module 91 of the user information database provides user profile information to an SDN controller via an Ss interface with the SDN controller. For example, the first providing module 91 may perform a match query so as to obtain profile information of one or more users needed by the SDN controller, and then transmits to the SDN controller via the Ss interface. In one embodiment, when the user initially accesses, the first providing module 91 will transmit the user profile information of the user to the SDN controller via the Ss interface, which will be further described with reference to FIG. 4 hereinafter. In a further embodiment, when the user requests for using the service, the first providing module 91 transmits the user profile information of the user to the SDN controller via the Ss interface based on the request of the SDN controller, which will be further described with reference to FIG. 5. In a still further embodiment, when the user requests for adding a new service, the first providing module 91 will update the user profile request information to the SDN controller based on the information transmitted based on the SDN controller, which will be further described with reference to FIG. 6.

FIG. 4 shows a message interacting diagram for communication between the SDN controller and the user information database when the user initially accesses in one preferred embodiment of the present invention.

In this embodiment, the first retrieving module 81 comprises a module configured to, when a user initially accesses, receive a user profile information download notification message for the user transmitted by the user information database via the Ss interface with the user information database, hereinafter referred to as a first receiving module 811 (not shown); a module configured to obtain a user profile information of the user based on the user profile information download notification message, hereinafter referred to as a second retrieving module 812 (not shown); and a module configured to transmit the user profile information download report message for the user to the user profile database via the Ss interface with the user information database based on the result of obtaining the user profile information of the user, hereinafter referred to as a first transmitting module 813 (not shown). Besides that, the first providing module 91 of the user information database includes a module configured to, when a user initially accesses, transmit a user profile information download notification message for the user to an SDN controller via an Ss interface with the SDN controller, wherein the user profile information download notification message includes user profile information of the user, hereinafter referred to as a second providing module 911 (not shown); and a module configured to receive a user profile message download report message for the user transmitted by the SDN controller via the Ss interface with the SDN controller, hereinafter referred to as a second receiving module 912 (not shown).

Firstly, in step 401, when the user initially accesses, the second providing module 911 of the user information database transmits a user profile information download notification message of the user to the SDN controller, wherein the user profile information download notification message includes the user profile information of the user. At the ease of reading, the user profile information download notification message will be shortly referred to as a PDN message, i.e., a Profile-Download-Notify message. Here, the user may access to the SDN network by for example turning on a mobile terminal. Because those skilled in the art already know the technology of user initial access, it will not be detailed here. When the user information database obtains the user initial access, the second providing module 911 of the user information database queries the user profile information of the user to include the user profile information of the user in the PDN message, and transmits the PDN message to the SDN controller via the Ss interface. Hereinafter, as a specific example of the PDN message, the PDN message includes, but not limited to the following information:

Profile-Download-Notify (PDN):

user identity identification;

SDN controller identification;

user subscribed service;

user priority;

user QoS demand;

congestion backup path of a user service.

Then, in step S402, the first receiving module 811 of the SDN controller receives the user profile information download notification message of the user as transmitted by the user information database. For example, the first receiving module 811 of the SDN controller may receive the PDN message transmitted by the user information database based on event trigger or periodically through the Ss interface. As mentioned above, the PDN message includes the user profile information of the user.

Next, in step S403, the second retrieving module 812 of the SDN controller obtains the user profile information of the user based on the PDN message. For example, after the first receiving module 811 of the SDN controller receives the PDN message via the Ss interface, the second retrieving module 812 of the SDN controller may identify whether it belongs to its own to-be-processed message based on the SDN controller identification included in the message, and then extracts the user profile information for the user from the PDN message. The second retrieving module 812 of the SDN controller may also store the user profile information of the user locally so as to avoid repetitively querying the user profile information of the user to the user information database.

Next, in step S404, the first transmitting module 813 of the SDN controller transmits the user profile information download report message for the user to the user information database via the Ss interface with the user information database based on the result of obtaining the user profile information of the user. At the ease of reading, the user profile information download report message is simply referred to as PDR, i.e., Profile Download Report message. The PDR message may include whether the above PDN message is successfully received by the SDN controller as mentioned above, i.e., whether the SDN controller has successfully retrieved the indication information of the user profile information of the user. If the PDN controller fails to retrieve the user profile information of the user from the PDN message, the first transmitting module 813 of the SDN controller may also comprise information such as failure cause in the PDR message. A specific example of the PDR message is provided below, wherein the PDR message includes, but not limited to, the following information:

Profile-Download-Report (PDR):

user identity identification;

SDN controller identification;

PDN receive success or failure;

when receive fails, also include the failure cause.

In step S405, the SDN controller controls the user's data flow based on the obtained user profile information. For example, the SDN controller may perform route selection to the user's data flow according to the manner described above, e.g., allocating appropriate Enablers for the user's service data flow.

The following is an example of the processing procedure of the SDN controller and the user information database during the user's initial access process. In the example, user A registers the e-mail service, user A is a VIP user. When the user A accesses a network, the second providing module 911 of the user information database will transmit user A's user profile information to the SDN controller via the Ss interface, and the first receiving module 811 of the SDN controller receives and stores the user A's user profile information in the SDN controller. Then, the second retrieving module 812 of the SDN controller understands that user A subscribes an e-mail service based on user A's user profile information, and the control module 82 of the SDN controller will allocate Enablers suitable to be sent by the e-mail service for user A. For example, Enabler 1, Enabler 5, Enabler 6 are all suitable for e-mail service transmission; the control module 82 of the SDN controller selects Enabler 5 with the lightest service load based on the user A's priority being VIP so as to transmit the e-mail service for user A.

FIG. 5 shows a message interaction diagram for communication between an SDN controller and the user information database when the user performs service application in a preferred embodiment of the present invention.

In this embodiment, the first retrieving module 81 of the SDN controller comprises a module configured to transmit a user profile information query request message for a user to a user information database via an Ss interface with the user information database based on a request of the user for using a service, hereinafter referred to as a second transmitting module 814 (not shown); a module configured to receive a user profile information query answer message for the user transmitted by the user information database via the Ss interface with the user information database, hereinafter referred to as a third receiving module 815 (not shown); and a module configured to obtain the user profile information of the user based on the user profile information query answer message for the user, hereinafter referred to as a third retrieving module 816 (not shown). Besides that, the first providing module 91 of the user information database comprises a module configured to receive a user profile information query request message for a user transmitted by an SDN controller via an Ss interface with the SDN controller, hereinafter referred to as a fourth receiving module 913 (not shown); a module configured to query based on the user profile information query request message for the user to obtain user profile information of the user, hereinafter referred to as a first query module 914 (not shown); and a module configured to transmit a user profile information query answer message for the user to the SDN controller via the Ss interface with the SDN controller, wherein the user profile information query answer message includes the user profile information of the user, hereinafter referred to as a third transmitting module 915 (not shown).

First, in step S501, when the user initiates a service request, the second transmitting module 814 of the SDN controller transmits the user profile information query message for the user to the user information database via an Ss interface with the user information database. At the ease of reading, the user profile information query request message will be shortly referred to as PQR, i.e., Profile-Query-Request message. Here, the user may initiate a service request through a user equipment, e.g., via a mobile terminal. Because those skilled in the art known the technology of the user service request process, it will not be detailed here. After the SDN controller knows the user's service request information, the second transmitting module 814 of the SDN controller transmits a PQR message to the user information database via the Ss interface, the PQR message including the user identity identification and an indication of the user profile information needed by the SDN controller. In a preferred embodiment, after the SDN controller obtains the user's service request information, the user profile information of the user is searched locally at the SDN controller by the second transmitting module 814 based on the user identity identification included in the request. When the second transmitting module 814 of the SDN controller cannot locally find the latest user profile information of the user, by the second transmitting module 814 transmits a PQR message to the user information database via the Ss interface so as to request for the user profile information of the user.

Hereinafter, a specific example of the PQR message is shown, wherein the PQR message includes, but not limited to, the following information:

PQR (Profile-Query-Request):

user identity identification;

SDN controller identification;

user profile information needed by the SDN controller;

user priority;

congestion backup path;

other needed information.

Next, in step S502, the fourth receiving module 913 of the user information database receives the user profile information query request message for the user transmitted by the SDN controller via an Ss interface with the SDN controller. For example, the fourth receiving module 913 may receive the PQR message transmitted by the SDN controller based on event-trigger or periodically via the Ss interface. As mentioned above, in the PQR message, there includes a user identity identification and an indication of the user profile information needed by the SDN controller, etc.

Next, in step S503, the first query module 914 of the user information database performs query based on the user profile information query request message for the user to obtain the user profile information of the user. For example, after receiving the PQR message via an Ss interface, the first query module 914 of the user information database may query the profile information of the user based on the user identity identification included in the message, and then finds the content items of the user profile information needed by the SDN controller from the user profile information.

Next, in step S504, the third transmitting module 915 of the user information database transmits the user profile information query answer message for the user to the SDN controller via an Ss interface with the SDN controller, wherein the user profile information query answer message includes the user profile information of the user. At the ease of reading, the user profile information query answer message is simply referred to as PQA, i.e., Profile-Query-Answer message. The PQA message refers to the answer of the user information database to the PQR request message transmitted by the SDN controller, including an indication for answering whether the PQR request succeeds or fails. If the first query module 914 successfully queries the profile information of the user, the third transmitting module 915 indicates that the request succeeds in the PQA message, and includes, in the message, the content of the user profile information applied by the user; if the first query module 914 fails to query the profile information of the user, the third transmitting module 915 indicates a failure request in the PQA message, and provides information such as the cause of the failure or the next action suggestion. Hereinafter, a specific example of the PQA message is provided, wherein the PQA message includes, but not limited to, the following information:

PQA (Profile-Query-Answer):

request confirmation indication, success or failure;

if the request succeeds, provide the user profile information of the user;

if the request fails, provide the cause of failure or the next step of action, etc.

In step S505, the third receiving module 815 of the SDN controller receives the user profile information query answer message for the user transmitted by the user information database. For example, the third receiving module 815 may receive the PQA message transmitted by the user information database based on event trigger or periodically via the Ss interface. As mentioned above, in the PQA message, there includes the user profile information requested by the SDN controller.

In step S506, the third retrieving module 816 of the SDN controller obtains the user profile information of the user based on the user profile information query answer message for the user. For example, the third retrieving module 816 obtains the content of the user profile information of the user in the PQA message based on the PQA message and saves the content of the user profile information of the user locally.

In step S507, the SDN controller controls the user's data flow based on the obtained user profile information. For example, the SDN controller may perform route selection of the user's data flow according to the manner described in step S22, e.g., allocating appropriate Enablers for the user's service data flow.

Hereinafter, during the user's service request process, an example of the SDN controller and the user information database processing procedure is provided. User A registers the e-mail service, while user A is a VIP user. When the user A initiates an e-mail service request, the SDN controller will receive information about user A's service request. The second transmitting module 814 of the SDN controller queries the user profile information of the user A. If the SDN controller does not have the user profile information or the latest user profile information of the user A, the second transmitting module 814 transmits a PQR message to the user information database. After the fourth receiving module 913 of the user information database receiving the PQR message, the first query module 914 queries to obtain the user profile information of the user A, the third transmitting module 915 transmits it to the SDN controller via the PQA message. The third retrieving module 816 of the SDN controller retrieves the user profile information of the user, and stores it in the SDN controller. The SDN controller understands that the user A has subscribed for the e-mail service based on the user profile information of the user A, and the SDN controller will allocate Enablers suitable for e-mail service transmission for the user A's e-mail service data flow. For example, Enabler 1, Enabler 5 and Enabler 6 are all suitable for e-mail service transmission; the SDN controller selects Enabler 5 with the lightest service load for the user A to transmit the e-mail service based on the user A's priority.

FIG. 6 shows a message interaction diagram for communication between the SDN controller and the user information database when the user registers a new service in one preferred embodiment of the present invention.

In this embodiment, the first retrieving module 81 of the SDN controller comprises a module configured to, based on a request of a user for adding a new service, transmit a user profile information update request message for the user to a user information database via an Ss interface with the user information database, wherein the user profile information update request message includes information of the new service the user requests to add, hereinafter referred to as a fourth transmitting module 817 (not shown); a module configured to receive a user profile information update answer message for the user transmitted by the user information database via the Ss interface with the user information database, wherein the user profile information update answer message includes user profile information related to the new service, hereinafter referred to as a fifth receiving module 818 (not shown); and a module configured to update the user profile information of the user based on the user profile information update answer message for the user, hereinafter referred to as a first updating module 819 (not shown). Besides that, the first providing module 91 of the user information database comprises a module configured to receive a user profile information update request message for a user transmitted by an SDN controller via an Ss interface with the SDN controller, wherein the user profile information update request message includes information of a new service the user requests to add, hereinafter referred to as a sixth receiving module 916 (not shown); a module configured to determine user profile information related to the new service the user requests to add based on the user profile information update request message for the user, hereinafter referred to as a first determining module 917 (not shown); and a module configured to transmit a user profile information update answer message for the user to the SDN controller via the Ss interface with the SDN controller, wherein the user profile information update answer message includes the user profile information related to the new service, hereinafter referred to as a fifth transmitting module 918 (not shown).

First, in step S601, when the user registers a new service, the fourth transmitting module 817 of the SDN controller transmits the user profile information update request message for the user to the user information database via an Ss interface with the user information database based on the user's request for adding a new service, wherein the user profile information update request message includes information of the new service the user requests to add. At the ease of reading, the user profile information update request message is shortly referred to as PUR, i.e., Profile-Update-Request message. Here, the user may initiate a new service registration request through the user equipment, e.g., the mobile terminal. Because those skilled in the art have known the technology of the user new service registration request procedure, it will not be detailed here. After the SDN controller knows the user's new service registration request information, the fourth transmitting module 817 transmits a PUR message to the user information database based on the type of the service newly registered included in the request. The PUR message includes the service information newly registered by the user:

PUR (Profile-Update-Request):

user identity identification;

SDN controller identification;

information of service newly registered by the user.

Then, in step S602, the sixth receiving module 916 of the user information database receives the user profile information update request message for the user transmitted by the SDN controller via an Ss interface with the SDN controller, wherein the user profile information update request message includes the information of a new service the user requests to add. For example, the sixth receiving module 916 may receive the PUR message transmitted by the SDN controller based on event trigger or periodically via the Ss interface. As mentioned above, the PUR message includes information of the new service the user requests to add.

Next, in step S603, the first determining module 917 of the user information database determines the user profile information related to the new service as the user requests to add based on the user profile information update request message for the user. For example, after the sixth receiving module 916 receiving the PUR message via the Ss interface, the first determining module 917 may determine information related to the new service the user requests to add, e.g., whether the user successfully subscribes the service, charging information, etc., and saves the information in the user profile information of the user.

Next, in step S604, the fifth transmitting module 918 of the user information database transmits the user profile information update answer message for the user to the SDN controller via an Ss interface with the SDN controller, wherein the user profile information update answer message includes the user profile information related to the new service. At the ease of reading, the user property information update answer message is shortly referred to as PUA, i.e., Profile-Update-Answer message. The PUA message is an answer message of the user information database to the PUR request message transmitted by the SDN controller, wherein it may be included in the user profile information related to the new service as determined in step S603. Besides, the PUA message may also include an indication of answering to whether the PUR request succeeds or fails. If the user information database successfully updates the user profile information, the fifth transmitting module 918 of the user information database transmits an indication of confirming success in the PUA message; if the user information database fails to update the user profile information, the fifth transmitting module 918 of the user information database provides information such as the cause of failure or the next action suggestion in the PUA message. Hereinafter, a specific example of the PUA message is provided, wherein the PUA message includes, but not limited to the following information:

PUA (Profile-Update-Answer):

user profile information related to the new service;

confirming update success or failure;

in the case of failure, providing the cause of failure and the next step of action, etc.

In step S605, the fifth receiving module 818 of the SDN controller receives the user profile information update answer message for the user transmitted by the user information database via an Ss interface with the user information database, wherein the user profile information update answer message includes user profile information related to the new service. For example, the fifth receiving module 818 may receive the PUA message transmitted by the user information database based on event trigger or periodically via the Ss interface. As mentioned above, the PUA message includes the user profile information related to the new service.

In step S606, the first updating module 819 of the SDN controller updates the user profile information of the user based on the user profile information update answer message for the user. For example, the first updating module 819 of the SDN controller may obtain the user profile information of the user related to the new service from the PUA message after the fifth receiving module 818 receiving the PUA message via an Ss interface. The first updating module 819 may save the information in the SDN controller locally.

In step S607, the SDN controller controls the user's data flow based on the obtained user profile information. For example, the SDN controller may perform route selection to the user's data flow according to the manner described above in step S22, e.g., allocating appropriate Enablers for the user's service data flow.

Hereinafter, an example of SDN controller and user information database processing procedure is provided during the process of the user's new service registration. In the present example, the user A has previously accessed the network and has registered the e-mail service. The user A wants to register a new service, e.g., a YouTube video watching service. The user A transmits a request for registering the YouTube video watching service to the SDN network. The SDN controller receives the information about the user A's request for registering the YouTube video watching service; the fourth transmitting module 817 of the SDN controller transmits the information of the user A newly request service to the user information database via the PUR message. After the sixth receiving module 916 of the user information database receiving the PUR message, the first determining module 917 adds, in the user A's profile information, YouTube video watching service-related user profile information, e.g., its charging information, and the fifth transmitting module 918 transmits the PUA message to the SDN controller, and includes the user A's user profile information related to YouTube video watching service in the PUA message. After the fifth receiving module 818 of the SDN controller receiving the PUA message, the first updating module 819 obtains user A's user profile information related to YouTube video watching service therefrom and updates the locally stored user profile information of the user A. Finally, the SDN controller determines a route and notifies it to appropriate Enablers for user A's YouTube video watching service data flow based on the latest user profile information of the user A.

FIG. 7 shows a message interaction diagram of a congestion backup path for communication between the SDN controller and the user information database to update user service according to one preferred embodiment of the present invention.

In this embodiment, the apparatus for controlling user data flow in the SDN controller further comprises a module configured to record a path taken by a service of the user when a preceding congestion occurs as a congestion backup path of the service of the user, hereinafter referred to as a first recording module 83 (not shown); a module configured to transmit a user profile information update request message for the user to the user information database via the Ss interface with the user information database, wherein the user profile information update request message includes the congestion backup path of the service of the user, hereinafter referred to as a sixth transmitting module 84 (not shown); and a module configured to receive a user profile information updating answer message for the user transmitted by the user information database via the Ss interface with the user information database, hereinafter referred to as a seventh receiving module 85 (not shown). Besides that, the apparatus for facilitating controlling user data flow in the user information database further comprises a module configured to receive a user profile information update request message for a user transmitted by an SDN controller via an Ss interface with the SDN controller, wherein the user profile information update request message includes a congestion backup path of a service of the user, hereinafter referred to as a eighth receiving module 92 (not shown); a module configured to save the congestion backup path of the service of the user in the user profile information of the user based on the user profile information update request message for the user, hereinafter referred to as a first saving module 93 (not shown); and a module configured to transmit a user profile information update answer message for the user to the SDN controller via the Ss interface with the SDN controller, hereinafter referred to as a seventh transmitting module 94 (not shown).

In step S701, the first recording module 83 of the SDN controller records a path taken by a service of the user when a preceding congestion occurs as a congestion backup path for the service of the user. For example, when congestion occurs, the control module 82 of the SDN controller will select other available path for the service of the user, and the first recording module 83 takes the path as the congestion backup path of the service of the user, and records it locally.

In step S702, the sixth transmitting module 84 of the SDN controller transmits the user profile information update request message for the user to the user information database via an Ss interface with the user information database, wherein the user profile information update request message includes a congestion backup path for the service of the user. In step S703, the eighth receiving module 92 of the user information database receives the user profile information update request message for the user transmitted by the SDN controller via an Ss interface with the SDN controller, wherein the user profile information update request message includes a congestion backup path of the service of the user. For example, the eighth receiving module 92 of the user information database may receive the PUR message transmitted by the SDN controller based on event trigger or periodically through the Ss interface. As mentioned above, in the PUR message, there includes information regarding a congestion backup path of the user's service.

In step S704, the first saving module 93 of the user information database saves the congestion backup path of the user's service into the user profile information of the user based on the user profile information update request message for the user. For example, after the eighth receiving module 92 of the user information database receiving the PUR message via the Ss interface, the first saving module 93 may retrieve information regarding the congestion backup path of the user's service, and saves the information in the user profile information of the user.

Next, in step S705, the seventh transmitting module 94 of the user information database transmits the user profile information update answer message for the user to the SDN controller via an Ss interface with the SDN controller, wherein the user profile information update answer message includes the user profile information related to a congestion backup path of the user's service.

In step S706, the seventh receiving module 85 of the SDN controller receives the user profile information update answer message for the user transmitted by the user information database via an Ss interface with the user information database, wherein the user profile information update response message includes the user profile information related to the congestion alternative path of the user's service. For example, the seventh receiving module 85 may receive the PUA message transmitted by the user information database based on event trigger or periodically via the Ss interface.

It should be noted that the present invention may be implemented in software and/or a combination of software and hardware. For example, each module of the present invention may be implemented by an application-specific integrated circuit (ASIC) or any other similar hardware device. In one embodiment, the software program of the present invention may be executed through a processor to implement the steps or functions as mentioned above. Likewise, the software program (including relevant data structure) of the present invention may be stored in a computer readable recording medium, e.g., RAM memory, magnetic or optic driver or soft floppy or similar devices. Additionally, some steps or functions of the present invention may be implemented by hardware, for example, a circuit cooperating with the processor so as to implement various steps of functions.

To those skilled in the art, it is apparent that the present invention is not limited to the details of the above exemplary embodiments, and the present invention may be implemented with other embodiments without departing from the spirit or basic features of the present invention. Thus, in any way, the embodiments should be regarded as exemplary, not limitative; the scope of the present invention is limited by the appended claims, instead of the above depiction. Thus, all variations intended to fall into the meaning and scope of equivalent elements of the claims should be covered within the present invention. No reference signs in the claims should be regarded as limiting the involved claims. Besides, it is apparent that the term “comprise” does not exclude other units or steps, and singularity does not exclude plurality. A plurality of units or modules stated in a system claim may also be implemented by a single unit or module through software or hardware. Terms such as the first and the second are used to indicate names, but do not indicate any particular sequence.

Although the exemplary embodiments have been specifically illustrated and described above, those skilled in the art would understand that without departing from the spirit and scope of the claims, their forms and details may change somewhat. What is sought for protection here is illustrated in the appended claims. In the following numbered provisions, these and other aspects of various embodiments are prescribed.

1. A method for controlling a user data flow in an SDN controller of an SDN network, comprising:

obtaining user profile information from a user information database via an Ss interface with the user information database;

controlling a data flow of a user based on the user profile information.

2. The method according to provision 1, wherein the step of obtaining user profile information from a user information database via an Ss interface with the user information database comprises:

when a user initially accesses, receiving a user profile information download notification message for the user transmitted by the user information database via the Ss interface with the user information database;

obtaining a user profile information of the user based on the user profile information download notification message;

based on the result of retrieving the user profile information of the user, transmitting the user profile information download report message for the user to the user profile database via the Ss interface with the user information database.

3. The method according to provision 1, wherein the step of obtaining user profile information from a user information database via an Ss interface with the user information database comprises:

transmitting a user profile information query request message for a user to a user information database via an Ss interface with the user information database based on a request of the user for using a service;

receiving a user profile information query answer message for the user transmitted by the user information database via the Ss interface with the user information database;

obtaining the user profile information of the user based on the user profile information query answer message for the user.

4. The method according to provision 1, wherein the step of obtaining user profile information from a user information database via an Ss interface with the user information database comprises:

based on a request of a user for adding a new service, transmitting a user profile information update request message for the user to a user information database via an Ss interface with the user information database, wherein the user profile information update request message includes information of the new service the user requests to add;

receiving a user profile information update answer message for the user transmitted by the user information database via the Ss interface with the user information database, wherein the user profile information update answer message includes user profile information related to the new service;

updating the user profile information of the user based on the user profile information update answer message for the user.

5. The method according to any one of provisions 1-4, wherein the method further comprises:

recording a path taken by a service of a user when a preceding congestion occurs as a congestion backup path of the service of the user;

transmitting a user profile information update request message for the user to the user information database via the Ss interface with the user information database, wherein the user profile information update request message includes the congestion backup path of the service of the user;

receiving a user profile information updating answer message for the user transmitted by the user information database via the Ss interface with the user information database.

6. The method according to any one of provisions 1 to 5, wherein the control comprises at least one of the following:

route selection;

permission control.

7. The method according to any one of provisions 1-6, wherein the user profile information includes at least any one of the following:

user identity identification;

user priority;

user subscribed service;

user QoS demand;

congestion backup path for a service of a user.

8. The method according to any one of provisions 1-7, wherein the user information database comprises at least one of the following:

UDB;

SPR.

9. A method for facilitating control of a user data flow in a user information database of an SDN network, the method comprising:

providing a user profile information to an SDN controller via an Ss interface with the SDN controller.

10. The method according to provision 9, wherein the step of providing user profile information to an SDN controller via an Ss interface with the SDN controller comprises:

when a user initially accesses, transmitting a user profile information download notification message for the user to an SDN controller via an Ss interface with the SDN controller, wherein the user profile information download notification message includes user profile information of the user;

receiving a user profile message download report message for the user transmitted by the SDN controller via the Ss interface with the SDN controller.

11. The method according to provision 9 or 10, wherein the step of providing a user profile information to an SDN controller via an Ss interface with the SDN controller comprises:

receiving a user profile information query request message for a user transmitted by an SDN controller via an Ss interface with the SDN controller;

querying based on the user profile information query request message for the user to obtain user profile information of the user;

transmitting a user profile information query answer message for the user to the SDN controller via the Ss interface with the SDN controller, wherein the user profile information query answer message includes the user profile information of the user.

12. The method according to any one of provisions 9-11, wherein step of providing a user profile information to an SDN controller via an Ss interface with the SDN controller comprises:

receiving a user profile information update request message for a user transmitted by an SDN controller via an Ss interface with the SDN controller, wherein the user profile information update request message includes information of a new service the user requests to add;

determining user profile information related to the new service the user requests to add based on the user profile information update request message for the user;

transmitting a user profile information update answer message for the user to the SDN controller via the Ss interface with the SDN controller, wherein the user profile information update answer message includes the user profile information related to the new service.

13. The method according to any one of provisions 9-12, the method further comprising:

receiving a user profile information update request message for the user transmitted by an SDN controller via an Ss interface with the SDN controller, wherein the user profile information update request message includes a congestion backup path of a service of the user;

saving the congestion backup path of the service of the user in the user profile information of the user based on the user profile information update request message for the user;

transmitting a user profile information update answer message for the user to the SDN controller via the Ss interface with the SDN controller.

14. The method according to any one of provisions 9-13, wherein the user profile information comprises at least one of the following:

user identity identification;

user priority;

user subscribed service;

user QoS demand;

congestion backup path of a service of a user.

15. The method according to any one of provisions 9-14, wherein the user information database includes any one of the following:

UDB;

SPR.

16. An apparatus for controlling a user data flow in an SDN controller of an SDN network, comprising:

a module configured to obtain user profile information from a user information database via an Ss interface with the user information database;

a module configured to control a data flow of a user based on the user profile information.

17. The apparatus according to provision 16, wherein the module configured to obtain user profile information from a user information database via an Ss interface with the user information database comprises:

a module configured to, when a user initially accesses, receive a user profile information download notification message for the user transmitted by the user information database via the Ss interface with the user information database;

a module configured to obtain a user profile information of the user based on the user profile information download notification message;

a module configured to, based on the result of obtaining the user profile information of the user, transmit the user profile information download report message for the user to the user profile database via the Ss interface with the user information database.

18. The apparatus according to provision 16, wherein the module configured to obtain user profile information from a user information database via an Ss interface with the user information database comprises:

a module configured to transmit a user profile information query request message for a user to a user information database via an Ss interface with the user information database based on a request of the user for using a service;

a module configured to receive a user profile information query answer message for the user transmitted by the user information database via the Ss interface with the user information database;

a module configured to obtain the user profile information of the user based on the user profile information query answer message for the user.

19. The apparatus according to provision 16, wherein the module configured to obtain user profile information from a user information database via an Ss interface with the user information database comprises:

a module configured to, based on a request of a user for adding a new service, transmit a user profile information update request message for the user to a user information database via an Ss interface with the user information database, wherein the user profile information update request message includes information of the new service the user requests to add;

a module configured to receive a user profile information update answer message for the user transmitted by the user information database via the Ss interface with the user information database, wherein the user profile information update answer message includes user profile information related to the new service;

a module configured to update the user profile information of the user based on the user profile information update answer message for the user.

20. The apparatus according to any one of provisions 16-19, wherein the apparatus further comprises:

a module configured to record a path taken by a service of the user when a preceding congestion occurs as a congestion backup path of the service of the user;

a module configured to transmit a user profile information update request message for the user to the user information database via the Ss interface with the user information database, wherein the user profile information update request message includes the congestion backup path of the service of the user;

a module configured to receive a user profile information updating answer message for the user transmitted by the user information database via the Ss interface with the user information database.

21. The apparatus according to any one of provisions 16 to 20, wherein the control comprises at least one of the following:

route selection;

permission control.

22. The apparatus according to any one of provisions 16-21, wherein the user profile information includes at least any one of the following:

user identity identification;

user priority;

user subscribed service;

user QoS demand;

congestion backup path for a service of a user.

23. The apparatus according to any one of provisions 16-22, wherein the user information database comprises at least one of the following:

UDB;

SPR.

24. An apparatus for facilitating control of a user data flow in a user information database of an SDN network, the apparatus comprising:

a module configured to provide a user profile information to an SDN controller via an Ss interface with the SDN controller.

25. The apparatus according to provision 24, wherein the module configured to provide user profile information to an SDN controller via an Ss interface with the SDN controller comprises:

a module configured to, when a user initially accesses, transmit a user profile information download notification message for the user to an SDN controller via an Ss interface with the SDN controller, wherein the user profile information download notification message includes user profile information of the user;

a module configured to receive a user profile message download report message for the user transmitted by the SDN controller via the Ss interface with the SDN controller.

26. The apparatus according to provision 24 or 25, wherein the module configured to provide a user profile information to an SDN controller via an Ss interface with the SDN controller comprises:

a module configured to receive a user profile information query request message for a user transmitted by an SDN controller via an Ss interface with the SDN controller;

a module configured to query based on the user profile information query request message for the user to obtain user profile information of the user;

a module configured to transmit a user profile information query answer message for the user to the SDN controller via the Ss interface with the SDN controller, wherein the user profile information query answer message includes the user profile information of the user.

27. The apparatus according to any one of provisions 24-26, wherein the module configured to provide a user profile information to an SDN controller via an Ss interface with the SDN controller comprises:

a module configured to receive a user profile information update request message for a user transmitted by an SDN controller via an Ss interface with the SDN controller, wherein the user profile information update request message includes information of a new service the user requests to add;

a module configured to determine user profile information related to the new service the user requests to add based on the user profile information update request message for the user;

a module configured to transmit a user profile information update answer message for the user to the SDN controller via the Ss interface with the SDN controller, wherein the user profile information update answer message includes the user profile information related to the new service.

28. The apparatus according to any one of provisions 24-27, the apparatus further comprising:

a module configured to receive a user profile information update request message for a user transmitted by an SDN controller via an Ss interface with the SDN controller, wherein the user profile information update request message includes a congestion backup path of a service of the user;

a module configured to save the congestion backup path of the service of the user in the user profile information of the user based on the user profile information update request message for the user;

a module configured to transmit a user profile information update answer message for the user to the SDN controller via the Ss interface with the SDN controller.

29. The apparatus according to any one of provisions 24-28, wherein the user profile information comprises at least one of the following:

user identity identification;

user priority;

user subscribed service;

user QoS demand;

congestion backup path of a service of a user.

30. The apparatus according to any one of provisions 24-29, wherein the user information database includes any one of the following:

UDB;

SPR.

1. A method for controlling a data flow of a user in an SDN controller of an SDN network, the method comprising:
obtaining user profile information from a user information database via an Ss interface with the user information database;
controlling a data flow of a user based on the user profile information.

2. A method for facilitating control of a data flow of a user in a user information database of an SDN network, the method comprising:
providing a user profile information to an SDN controller via an Ss interface with the SDN controller.

3. An apparatus for controlling a data flow of a user in an SDN controller of an SDN network, the apparatus comprising:
a module configured to obtain user profile information from a user information database via an Ss interface with the user information database;
a module configured to control a data flow of a user based on the user profile information.

4. The apparatus according to claim 3, wherein the module configured to obtain user profile information from a user information database via an Ss interface with the user information database comprises:
a module configured to, when a user initially accesses, receive a user profile information download notification message for the user transmitted by the user information database via the Ss interface with the user information database;
a module configured to obtain a user profile information of the user based on the user profile information download notification message;
a module configured to transmit the user profile information download report message for the user to the user profile database via the Ss interface with the user information database based on the result of obtaining the user profile information of the user.

5. The apparatus according to claim 3, wherein the module configured to obtain user profile information from a user information database via an Ss interface with the user information database comprises:
a module configured to transmit a user profile information query request message for a user to a user information database via an Ss interface with the user information database based on a request of the user for using a service;
a module configured to receive a user profile information query answer message for the user transmitted by the user information database via the Ss interface with the user information database;
a module configured to obtain the user profile information of the user based on the user profile information query answer message for the user.

6. The apparatus according to claim 3, wherein the module configured to obtain user profile information from a user information database via an Ss interface with the user information database comprises:
a module configured to, based on a request of a user for adding a new service, transmit a user profile information update request message for the user to a user information database via an Ss interface with the user information database, wherein the user profile information update request message includes information of the new service the user requests to add;
a module configured to receive a user profile information update answer message for the user transmitted by the user information database via the Ss interface with the user information database, wherein the user profile information update answer message includes user profile information related to the new service;
a module configured to update the user profile information of the user based on the user profile information update answer message for the user.

7. The apparatus according to claim 3, wherein the apparatus further comprises:
a module configured to record a path taken by a service of the user when a preceding congestion occurs as a congestion backup path of the service of the user;
a module configured to transmit a user profile information update request message for the user to the user information database via the Ss interface with the user information database, wherein the user profile information update request message includes the congestion backup path of the service of the user;
a module configured to receive a user profile information updating answer message for the user transmitted by the user information database via the Ss interface with the user information database.

8. The apparatus according to claim 3, wherein the control comprises at least one of the following:
route selection;
permission control.

9. The apparatus according to claim 3, wherein the user profile information includes at least any one of the following:
user identity identification;
user priority;
user subscribed service;
user QoS demand;
congestion backup path for a service of a user.

10. An apparatus for facilitating control of a data flow of a user in a user information database of an SDN network, the apparatus comprising:
a module configured to provide a user profile information to an SDN controller via an Ss interface with the SDN controller.

11. The apparatus according to claim 10, wherein the module configured to provide user profile information to an SDN controller via an Ss interface with the SDN controller comprises:
a module configured to, when a user initially accesses, transmit a user profile information download notification message for the user to an SDN controller via an Ss interface with the SDN controller, wherein the user profile information download notification message includes user profile information of the user;
a module configured to receive a user profile message download report message for the user transmitted by the SDN controller via the Ss interface with the SDN controller.

12. The apparatus according to claim 10, wherein the module configured to provide a user profile information to an SDN controller via an Ss interface with the SDN controller comprises:
a module configured to receive a user profile information query request message for a user transmitted by an SDN controller via an Ss interface with the SDN controller;
a module configured to query based on the user profile information query request message for the user to obtain user profile information of the user;
a module configured to transmit a user profile information query answer message for the user to the SDN controller via the Ss interface with the SDN controller, wherein the user profile information query answer message includes the user profile information of the user.

13. The apparatus according to claim 10, wherein the module configured to provide user profile information to an SDN controller via an Ss interface with the SDN controller comprises:
a module configured to receive a user profile information update request message for a user transmitted by an SDN controller via an Ss interface with the SDN controller, wherein the user profile information update request message includes information of a new service the user requests to add;
a module configured to determine user profile information related to the new service the user requests to add based on the user profile information update request message for the user;
a module configured to transmit a user profile information update answer message for the user to the SDN controller via the Ss interface with the SDN controller, wherein the user profile information update answer message includes the user profile information related to the new service.

14. The apparatus according to claim 10, the apparatus further comprising:
a module configured to receive a user profile information update request message for a user transmitted by an SDN controller via an Ss interface with the SDN controller, wherein the user profile information update request message includes a congestion backup path of a service of the user;
a module configured to save the congestion backup path of the service of the user in the user profile information of the user based on the user profile information update request message for the user;
a module configured to transmit a user profile information update answer message for the user to the SDN controller via the Ss interface with the SDN controller.

15. The apparatus according to claim 10, wherein the user profile information includes at least any one of the following:
user identity identification;
user priority;
user subscribed service;
user QoS demand;
congestion backup path for a service of a user.
